(19) United States
(12) Patent Application Publication
(10) Pub. No.: US 2007/0287441 A1
(43) Pub. Date: Dec. 13, 2007

(54) Apparatus and Method for Recommending the Spot or the Azit in the Regional Community System Based on Mobile Blog Through the Mobile Terminal

(76) Inventors: Hyuck Jin Im, Seoul (KR); Ji Hoon Kim, Seoul (KR); Kun Yong Park, Seoul (KR); Jung Wook Seo, Seoul (KR); Chester An, Seoul (KR); Yong Il Lee, Seoul (KR); Chol Hong Im, Seoul (KR); Jonathan Kim, Seoul (KR); Ui Chung Chung, Seoul (KR); Youn Kyung Go, Incheon (KR); Hyun Jung Kwon, Seoul (KR); Soo Jin Kim, Gyeonggi-Do (KR); Jae Hong Ahn, Seoul (KR); Don Hi Won, Seoul (KR); Sung Wha Shim, Seoul (KR)

Correspondence Address: RABIN & Berdo, PC, 1101 14TH STREET, NW, SUITE 500, WASHINGTON, DC, 20005, US

(21) Appl. No.: 11/572,375

(22) PCT Filed: Jul. 19, 2005
(86) PCT No.: PCT/KR05/02329

§ 371 Date: Jan. 19, 2007

(30) Foreign Application Priority Data
Jul. 20, 2004 (KR) 10-2004-0056212

(51) Int. Cl. H04Q 7/20

(52) U.S. Cl. 455/422.1

(57) ABSTRACT

Disclosed is a location-based community service provision system for setting a plurality of main arenas by dividing a geographical area in a regional unit, setting and storing one or more virtual spatial locations, the one or more virtual spatial locations being a projection of real spatial public locations, as spots in one of the main arenas, receiving information on posts registered in spots transmitted through a mobile terminal by providing one or more pieces of information on the spots belonging to the main arena from information on a location of the mobile terminal to the mobile terminal, and storing the received information on posts with a link with the spots. An apparatus for recommending a spot or an azit in a moblog-based regional community system using a mobile terminal, includes a recommendation system for executing a recommendation algorithm to recommend azits, spots, friends or neighbors for each user; a level system for setting and managing a level for each azit and spot according to a preset rule; and a link evaluator for performing an evaluation on each link and managing a result of the evaluation.

### BACKGROUND OF THE INVENTION

1. Technical Field

The present invention relates to a mobile blog system and method for registering and reading bulletins through a mobile terminal, and more particularly, to an apparatus and method for recommending spots or azits in mobile blog-based regional community services through mobile terminals.

2. Description of Prior Art

Earlier wireless Internet services, that is, Internet service using mobile terminals, have provided relatively simple contents such as ring-tone downloading, mobile games and the like. With change of environments such as opening of mobile communication networks, wired/wireless integrated Internet services based on user-based services of Platforms have been facilitated.

In addition, relational wired/wireless services for which wireless networks are linked with wired networks have been developed with increasing speed. For example, services, such as instant messengers, mobile mini homepages, mobile blogs and the like, using mobile terminals have been provided.

On the other hand, the up-to-date term ‘moblog’, which is a compound word of ‘mobile’ and ‘blog’, means a service provided to put contents such as writing, photography and the like in a blog on a web in real time using a mobile terminal.

The current moblog service has been achieved in such a manner that user's photographs or writing are delivered to servers or the users inquire photographs or writing registered in servers of the servers. In the moblog services, although real-time information on photographs and writing at a certain location is transformed and stored, information on the certain location is not inputted or must be separately inputted by a user. Accordingly, this information on the location is difficult to be searched for by persons other than a person in question, which may result in deterioration of value of the moblog service.

Accordingly, there is a keen need for a method of raising a degree of sharing of information on photographs and writing between users in the moblog services and a service method of supporting formation of human networks through formation of real-time communities. Furthermore, there is a need for methods of effectively recommending targets of message delivery and the likes in the moblog services using the mobile terminals.

### SUMMARY OF THE INVENTION

Therefore, it is an object of the present invention to provide a system and method for providing a moblog-based regional community service through a mobile terminal, which is capable of storing and sharing information related to experience suffered by users on the basis of actual locations or supporting meetings of users having the same concerns on the basis of the user's regions.

It is another object of the present invention to provide a system and method for providing a moblog-based regional community service through a mobile terminal, which is capable of publishing experience suffered by users at their locations in the form of photograph or writing through wired/wireless apparatuses or sharing stored information with other persons.

It is yet another object of the present invention to provide an apparatus and method for providing spots or azits in a moblog-based regional community system through a mobile terminal, which is capable of making new friends or neighbors by recommending recommended targets (azits) or spots using a recommendation algorithm in a moblog-based regional community service provision system.

To achieve the above objects, according to one aspect, the present invention provides an apparatus for recommending a spot or an azit in a moblog-based regional community system using a mobile terminal in a location-based community service provision system for setting a plurality of main arenas by dividing a geographical area in a regional unit, setting and storing one or more virtual spatial locations, the one or more virtual spatial locations being a projection of real spatial public locations, as spots in one of the main arenas, receiving information on posts registered in spots transmitted through a mobile terminal by providing one or more pieces of information on the spots belonging to the main arena from information on a location of the mobile terminal to the mobile terminal, and storing the received information on posts with a link with the spots. The apparatus includes a recommendation system for executing a recommendation algorithm to recommend azits, spots, friends or neighbors for each user; a level system for setting and managing a level for each azit and spot according to a preset rule; and a link evaluator for performing an evaluation on each link and managing a result of the evaluation.

According to another aspect, the present invention provides a method for recommending a spot or an azit in a moblog-based regional community system using a mobile terminal in a location-based community service provision system for setting a plurality of main arenas by dividing a geographical area in a regional unit, setting and storing one or more virtual spatial locations, the one or more virtual spatial locations being a projection of real spatial public locations, as spots in one of the main arenas, receiving information on posts registered in spots transmitted through a mobile terminal by providing one or more pieces of information on the spots belonging to the main arena from information on a location of the mobile terminal to the mobile terminal, and storing the received information on posts with a link with the spots. The method includes the steps of measuring a relationship between user's posts; measuring a link of a user's azit to other user's azits and/or spots; measuring activities performed by the user's azit; calculating levels of the azits and spots based on values derived from the measurements; calculating a recommendation priority based on a degree of relationship and a level of the user's post; and determining a recommendation target based on the calculated recommendation priority.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a main arena conceptual diagram illustrating conceptually a human network as a user's activity basis according to the present invention;

FIG. 2 is a link conceptual diagram illustrating a relationship between particular spots centered on an azit of a user and friends according to the present invention;

FIG. 3 is a diagram illustrating a moblog-based regional community service system using a mobile terminal according to the present invention;

FIG. 4 is a diagram illustrating a detailed configuration of a location-based community server and an external link system according to an embodiment of the present invention;

FIG. 5 is a diagram illustrating examples of a service enabled according to an embodiment of the present invention;

FIG. 6 is a conceptual diagram illustrating a flow of a service, which can be provided according to an embodiment of the present invention;

FIG. 7 is a flow chart illustrating a procedure of providing a moblog-based regional community service through a mobile terminal according to an embodiment of the present invention;

FIGS. 8 and 9 are diagrams illustrating a service method through a spot menu of a mobile terminal according to an embodiment of the present invention;

FIGS. 10 and 11 are diagrams illustrating a service method through an azit menu of a mobile terminal according to an embodiment of the present invention;

FIG. 12 is a diagram illustrating a service method through a buddy menu of a mobile terminal according to an embodiment of the present invention;

FIG. 13 is a diagram illustrating a method of appending a reply in an azit menu of a mobile terminal according to an embodiment of the present invention;

FIG. 14 is a diagram illustrating an entire service flow through a menu provided through a mobile terminal according to an embodiment of the present invention;

FIG. 15 is a diagram illustrating a service link procedure through spot, azit and buddy menus according to an embodiment of the present invention;

FIG. 16 is a diagram illustrating an execution procedure in a spot menu of a mobile terminal in a moblog-based regional community service according to an embodiment of the present invention;

FIG. 17 is a diagram illustrating a service use condition using an azit function in a moblog-based regional community service according to an embodiment of the present invention;

FIG. 18 is a block diagram illustrating a detailed structure of a recommendation engine for executing a recommendation algorithm according to an embodiment of the present invention;

FIG. 19 is a flow chart illustrating a procedure of recommending an azit according to an embodiment of the present invention;

FIG. 20 is a flow chart illustrating a procedure in which a condition of recommending a message target occurs according to an embodiment of the present invention;

FIG. 21 is a flow chart illustrating a procedure in which a condition of recommending a spot occurs according to an embodiment of the present invention; and

FIG. 22 is a flow chart illustrating a procedure in which a condition of recommending an azit occurs according to an embodiment of the present invention.

### DETAILED DESCRIPTION OF THE INVENTION

Hereinafter, preferred embodiments of the present invention will be described in detail with reference to the accompanying drawings. The following preferred embodiments are intended not to limit the scope of the present invention, but rather to provide a sufficient understanding of the present invention to those skilled in the art. Throughout the drawings, like reference numerals denote like elements.

The present invention suggests a novel method of introducing a concept of ‘location’ in an existing moblog service provided to record contents such as writing, photographs and the like in a blog on a web in real time using a mobile terminal and establishing communities between users by the medium of the location.

On the other hand, an essential concept of the present invention is in projecting an actual spatial location on a virtual spatial location. That is, an actual spatial location is mapped to a virtual spatial location in which information can be shared between users to allow them to bulletin the information or leave their remembrance and photographs that have been attained in the actual location. In addition, the present invention provides a free bulletin space where a variety of information and evaluation on a relevant location can be posted. Such an activity allows communities based on the location between users to be naturally established and facilitate meeting of the users on an actual off-line.

In addition, the present invention can perform a propensity evaluation on locations in a virtual space for each user and allow other users to search and visit their favorite locations. That is, various locations arousing relevant users proximity can be easily recommended or searched by setting a degree of proximity to each location for each user. Accordingly, locations frequently visited by users interested in particular issues (that is, other users having the same interest as a relevant user) in the virtual spatial location mapped to the actual spatial location can be recommended to the relevant user. In addition, information posted by users while the users visit a variety of locations can be apparently displayed and provided to the users through the user's terminal.

In addition, an embodiment of the present invention provides a recommendation method according to a recommendation algorithm in a moblog-based regional community system through a mobile terminal. In this case, the recommendation includes recommendation of spots, recommendation of azits and recommendation of targets of message delivery.

Hereinafter, several terms to be introduced to implement the present invention will be first defined.

The term ‘main arena’ as used herein is defined as a regional unit in an actual space divided according to the applicant of the present invention. The unit of the main arena may be expanded and divided in various forms of administrative units such as city, country, district, town, township, village or the like. For example, the unit of the main arena may have names of administrative districts such as Kangnam subway station, Apkoogung subway station, Jongro subway station and the like. The main arena is based on an actual location at which a user is currently located, and may be automatically set by detecting the user's location when the user moves to be within an area of a particular main arena.

The term ‘spot’ as used herein is defined as a virtual spatial location on which a particular location (or public place) in an actual space is projected. For example, the spot maybe a virtual spatial location having the same name as an actual spatial location such as a Rodeo street, Apkoojung Dong Hyundae department store, Yeoksam Dong Renaissance hotel or the like. In this case, one or more spots exist within a main arena to which a user belongs, the main arena can be automatically set according to information on current location of the user, and the user can select one of spots belonging to the main arena and participate in the selected spot.

The term ‘azit’ as used herein is defined as a virtual spatial location on which a home in an actual space is projected. That is, the azit is a human (friends and neighbors) formation space possessed by an individual and has a concept of an individual homepage. The term ‘post’ as used herein is defined as the unit of information, such as a user's concerns, photographs, writing and the like, recorded in the spot or the azit. An operation of recording the information in the spot or the azit is called ‘posting’.

In addition, the term ‘note (message)’ is defined as a notification or announcement service of informing friends or neighbors of a post prepared directly by a relevant user or posts prepared by other users. Such a note may be expanded to a short message service (SMS) or a multimedia message service (NMS).

On the other hand, the term ‘link’ as used herein is defined as a connection (for example, bookmark from an azit to a particular spot) of a user's human relationship (for example, a relationship between azits) to a user's concern (for example, spots). In this case, the user's human relationship may be managed to be divided into a friend relationship and a neighbor relationship.

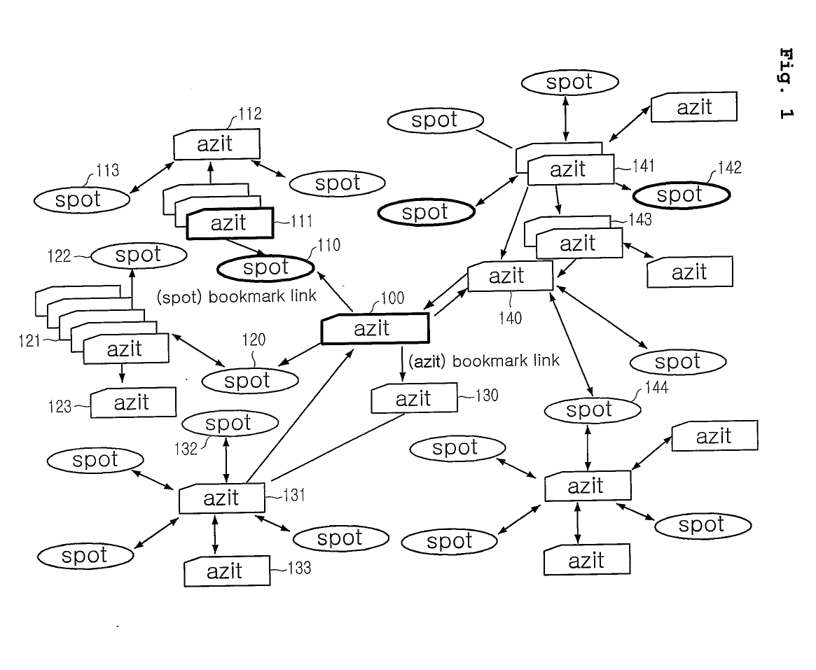

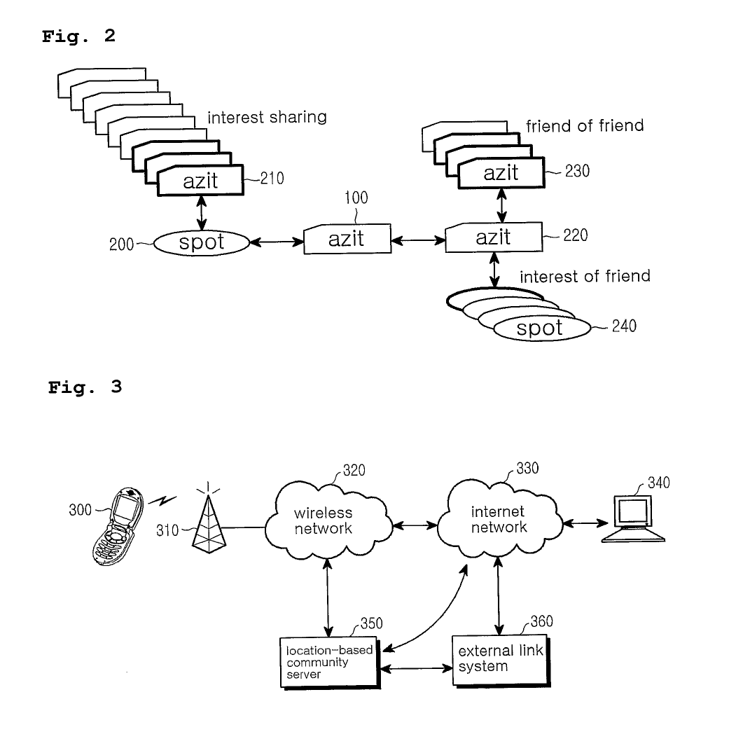

Hereinafter, a link formation relationship through spots, azits and the like in the main arena defined in the present invention will be described with reference to FIGS. 1 and 2.

FIG. 1 is a main arena conceptual diagram illustrating conceptually a human network as a user's activity basis according to the present invention. Referring to FIG. 1, one or more spots 110 and 120 and friend (or neighbor)'s azits 130 and 140 are linked to a particular user's azit (that is, my azit) 100.

Specifically, it can be seen from the figure that two spots 110 and 120 are linked to my azit 100. The spots 110 and 120 can be linked by bookmarking a relevant spot. On the other hand, bold spots 110, 142 and 144 or bold azits 100 and 111 shown in the figure or bold azits 100 and 111 mean a level for the spots and azits.

In addition, each of the spots can be linked to other azits. For example, the spot 110 can be linked to the azit 111 and the spot 120 can be linked to the azit 121. Bold links shown the figure mean strength of link indicating a degree of interest in a relevant spot or azit and a degree of activity.

In addition, two azits 130 and 140 are linked to my azit 100. As described above, the azit 130 becomes a neighbor azit linked simply when my azit 100 bookmarks and the azit 140 becomes a friend azit linked when my azit 100 requests the azit 140 to make friends and the azit 140 agrees to do so.

On the other hand, another azit 131 linked to the azit 130 can be one-sidedly linked to my azit 100. Of course, this azit 131 can be linked to one or more spots 132 and azits 133.

Likewise, the friend azit 140 linked to my azit 100 with a friend relationship can be linked to one or more azits 143 and spots 144, and the azit 143 linked to the friend azit 140 can be also linked to another azit 141 linked to one or more spots 142 and azits.

FIG. 2 is a link conceptual diagram illustrating a relationship between particular spots centered on an azit of a user and friends according to the present invention.

Referring to FIG. 2, as shown in FIG. 1, a spot 200 or a buddy azit 220 can be linked to my azit 100, and one or more spots 240 and azits 210 and 230 can be linked to the spot 200 and the buddy azit 220.

In this case, the spot linked to my azit 100 is a spot for a point in which the user is interested, and the azit 210 linked to the spot 200 linked to the my azit 100 can be assumed to have the same interest as my aizt 100. Accordingly, when a number of azits 100 and 210 linked to the spot 200 register writing in the spot 200 or readwriting from the spot 200, various interests related to the spot 200 can be shared. For example, assuming that a main arena of a user is ‘Kangnam subway station’ and a spot of ‘City theater’ is linked, when a number of users of spots linked to the spot of City theater register writing related to the location (for example, information related to movies or events) in the spot of City theater or read writing from the spot, various interests related to the relevant spot (i.e., a location as the same target) can be shared.

On the other hand, the present invention can perform a propensity evaluation on each of the spots for each user and allow other users to search and visit their favorite locations. That is, various locations arousing relevant users sympathy can be easily recommended or searched by setting a degree of sympathy to each spot for each user. Accordingly, spots frequently visited by persons having the same interest or propensity (for example, age, sex and the like) in virtual spatial locations, i.e., spots, mapped to actual spatial locations can be recommended to relevant users. In addition, information posted by users while the users visit a variety of spots can be apparently displayed and provided to the users through the user's terminal.

My azit 100 can form a human connection through the friend azit (i.e., the buddy azit) 220 as described above. That is, friend's interests and the like can be shared through spots 240 linked to the buddy azit 220, and, also, friend's friends can be known through azits 230 linked to the buddy azit 220. With such a link structure, a human relationship can be easily expanded through a virtual space according to a relevant user's interest.

On the other hand, the kind of the links as shown in FIG. 2 can be classified into the following three cases: first, an azit to azit link (human connection) including a link request and a link permission, second, an azit to spot link (URL (Uniform Resource Locator) bookmark) to specify a user's interest, and third, an azit to post link (URI (Uniform Resource Identifier) bookmark).

In addition, the present invention can effectively form a human network between users through the above-described link-based recommendation. The link-based recommendation can be classified into the following types: first, recommendation of new friends (azits) having a common interest post, second, recommendation of new friends (azits) based on a common interest location (spot), third, recommendation of other friends (azits) (i.e., friend's friends) in a human connection with a relevant friend (azit), fourth, recommendation of interest locations (spots) of friends (azits), and, fifth, recommendation of interest post of friends (azits).

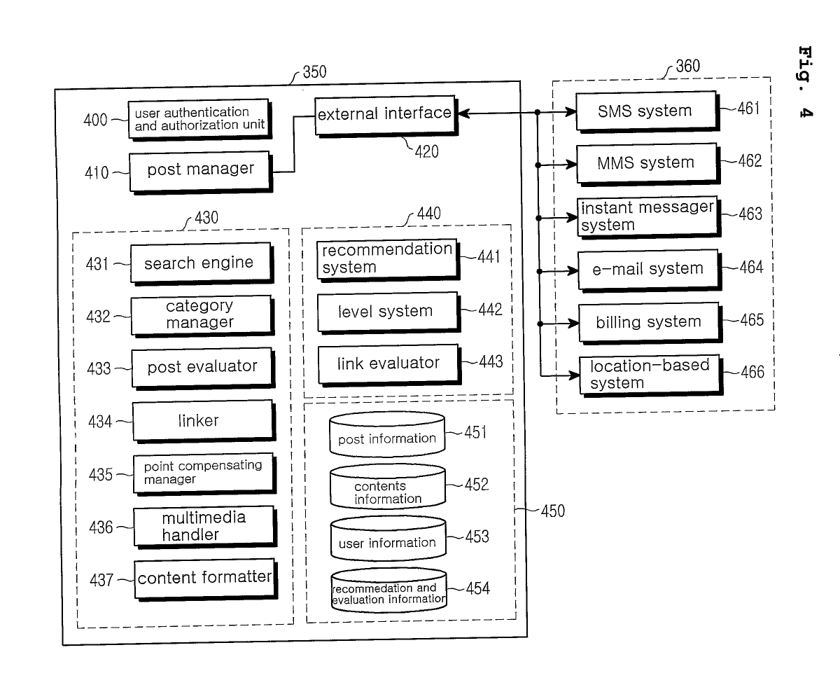

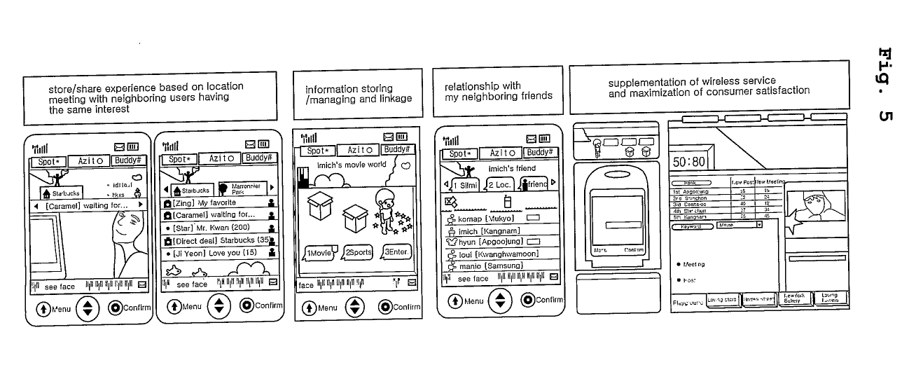

So far, the used terms and the concept of the human connection formation and the link to interest fields in the present invention have been described. Now, a system for implementing the present invention will be described with reference to FIGS. 3 and 4.

FIG. 3 is a diagram illustrating a moblog-based regional community service system using a mobile terminal according to the present invention. Referring to FIG. 3, a moblog-based regional community service system includes a mobile terminal 300, a wireless network termination apparatus 310, a wireless network 320, an Internet network 330, a wired terminal 340, a location-based community server 350, and an external link system 360.

A moblog-based regional community service according to the present invention is provided to a user through his mobile terminal 300, and a location (i.e., a main arena) of the user carrying the mobile terminal 300 is detected through location information of the mobile terminal 300. The wireless network termination apparatus 310, including base stations and base station controllers, processes signals received from the mobile terminal 300 via any wireless environments and transmits the processed signals to wired/wireless networks. On the other hand, the wireless network 320 call-processes packet or circuit signals received from the mobile terminal 300 and transmits the call-processed signals to relevant terminals. Also, the wireless network 320 is linked to the Internet network 330 (i.e., a wired network) and the location-based community server 350.

That is, the wireless network 320 communicates with the Internet network 330 via a gateway or the like and is connected to the wired terminal 340 via the Internet network 330. In this case, it should be understood that the present invention can be practiced irrespective of the kind of the wireless network 320 (for example, an asynchronous network, a synchronous network, or 2G, 3G and 4G networks).

On the other hand, the location-based community server 350 includes information on the above-described various azits, spots and buddies and information on their respective links and posts and controls the information. The location-based community server 350 is connected to one or more mobile terminal 300 via the wireless network 320 and can be also connected to the wired terminal 340 and the like via the Internet network 330. In this case, for provision of the service of the present invention through the location-based community server 350, the wireless network 320 and the location-based community server 350 may be configured as an intelligent network such that the present invention can be implemented without changing the configuration of the wireless network 320.

In addition, the location-based community server 350 can provide services more effectively by being linked to various external link systems 360. For example, the location-based community server 350 can provide relevant services to users through a link to a short message system, an instant messenger system, an e-mail system and the like. Particularly, it is preferable that the location-based community server 350 is linked to different location-based systems so that the location-based community server 350 can provide location-based services to the users.

Hereinafter, the location-based community server 350 and the external link system 360 to be provided according to an embodiment of the present invention will be described in detail with reference to FIG. 4.

FIG. 4 is a diagram illustrating a detailed configuration of the location-based community server and the external link system according to an embodiment of the present invention. Referring to FIG. 4, as shown in FIG. 3, the service according to an embodiment of the present invention is provided through a link between the location-based community server 350 and one or more external link systems 360.

The location-based community server 350 may include a user authentication and authorization unit 400, a post manager 410, an external interface 420, a service management module 430, a recommendation algorithm module 440, and a database unit 450.

The user authentication and authorization unit 400 performs a function of authentication and authorization for users. The post manager 410 performs a function of input, correction, deletion, inquiry and photograph registration of posts as an information registration unit. The external interface 420 performs a function of interface for data exchange between the location-based community server 350 and the external link system 360 to be linked to the location-based community server 350.

The service management module 430 includes various functions required to carry out embodiments of the present invention. For example, the service management module 430 may include a search engine 431, a category manager 432, a post evaluator 433, a linker 434, a point compensating manager 435, a multimedia handler 436, a content formatter 437 and the like.

The search engine 431 performs a function of searching posts or azits using keywords inputted from users and outputting a search result. The category manager 432 performs a function of managing various categories provided according to the present invention. The post evaluator 433 performs a function of managing evaluation information on posts evaluated by other users. The linker 434 performs a function of managing a connection relationship between azits and posts, between azits and azits, and between azits and spots. The point compensating manager 435 performs a function of managing points provided according to use results of users and compensation given according to the points. The multimedia handler 436 performs a function of managing various multimedia information provided according to the present invention or registered by the users. The content formatter 437 performs a function of formatting the above-mentioned information in a prescribed format such that various information generated and provided by the performance of the present invention can be configured on a screen in such a manner adapted to wired/wireless environments.

On the other hand, the recommendation algorithm module 440 performs a function of executing a recommendation algorithm to recommend azits, spot, posts and the like to the users. For example, the recommendation algorithm module 440 may include a recommendation system 441, a level (rank) system 442, and a link evaluator 443.

The recommendation system 441 executes a recommendation algorithm to recommend azits, spots, friends or neighbors for each user. The level system 442 performs a function of setting and managing a level for each azit and spot according to a prescribed rule. The link evaluator 443 performs a function of evaluating each link and managing a result of the evaluation.

In addition, the location-based community server 350 may include the database unit 450 consisting of various databases. For example, the database unit 450 includes a post information database 451, a contents information database 452, a user information database 453, a recommendation and evaluation information database 454 and the like.

The post information database 451 includes information on posts, the contents information database 452 includes information on various contents provided according to the present invention, the user information database 453 includes information on user's personal affairs and user log-in, and the recommendation and evaluation information database 454 includes information on recommendation of azits, spots, posts and the like and level evaluation.

On the other hand, as described above, the location-based community server 350 is linked to the external link system 360 in order provide various service according to the present invention.

The external link system 360 may include a SMS system 461, amms SYSTEM 462, an instant messenger system 463, an e-mail system 464, a billing system 465, a location-based system 466 and the like.

The SMS system 461 performs a function of transmitting short messages in a process of the present invention. The MMS system 462 performs a function of transmitting multimedia messages in a process of the present invention. In addition, the instant messenger system 463 performs a function of processing instant messages so that users can use an instant messenger function through wired/wireless terminals. The e-mail system 464 provides a function for e-mail transmission menus that can be used in a process of the present invention. The billing system 465 performs a function of billing users for service provided according to the present invention on a use amount basis or on a flat rate basis.

The location-based system 466 performs a function of providing information on each user's location in a process of the present invention. That is, the location-based system 466 detects information on a location of the mobile terminal 300 carried by each user and provides information on a main arena and the like to the user according to the present invention. On the other hand, how the location-based system 466 detects the information on the location of the mobile terminal 300 can be implemented in a various ways. For example, the location-based system 466 may use a global positioning system (GPS) or a cell ID search system using IDs of bases stations communicating with mobile terminals. Alternatively, the location-based system 466 may use a unique feature identifier (UFID) technique that can detect information on locations by the unit of building.

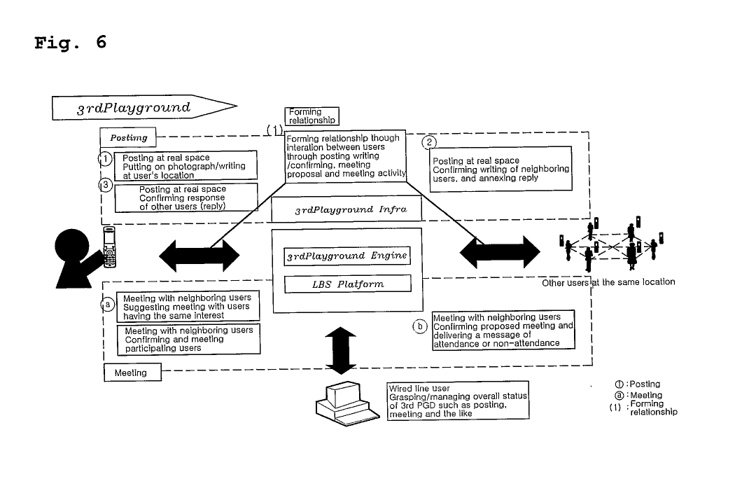

So far, the configuration of the system according to the present invention has been described. Hereinafter, procedures of services performed by the present invention will be described. First, services provided according to the present invention will be described with reference to FIGS. 5 and 6.

FIG. 5 is a diagram illustrating examples of a service enabled according to an embodiment of the present invention.

Referring to FIG. 5, service menus are provided through a mobile terminal according to an embodiment of the present invention First, meeting of neighboring users having the same interest can be induced by storing and sharing location-based experience according to an embodiment of the present invention.

That is, as shown in a first menu of FIG. 5, a service user can store or share experience suffered by him at his location with other users in terms of photographs, moving pictures, writing or the like. At this time, it is preferable that the mobile terminal has a camera function in order to register the photographs or moving pictures. Accordingly, neighboring users having the same interest can share their experience by registering photographs taken at a current location along with sentences written in relation with the photographs.

In addition, as shown in a second menu of FIG. 5, different users at the same location can share their experience registered by the same method. That is, different users who register posts in their spots can share their experience suffered at the same location through photographs or writing related to the spots.

In addition, as shown in a third menu of FIG. 5, information registered by a relevant user can be stored, managed, and inquired with links to regional locations and azits of other users.

In addition, as shown in a fourth menu of FIG. 5, in the service according to the present invention, a relevant user can search information on users registered as his buddy friends. That is, the relevant user can know conditions and activities of neighboring ones of his friends and communicate in real time with the neighboring friends.

On the other hand, the location-based moblog service system according to the present invention can be linked to the wired network as shown in FIG. 3. Accordingly, a relevant user can manage his buddies or posts or decorate his azit by accessing the above-described location-based community server 350 according to the present invention through his computer terminal connected to the Internet.

FIG. 6 is a conceptual diagram illustrating a flow of a service, which can be provided according to an embodiment of the present invention.

Referring to FIG. 6, according to an embodiment of the present invention, when a user registers photographs taken at a real space or writing or requests a meeting, other users in the same space and wired users can annex replies at the sight of the photographs and writing and notice the attendance or nonattendance at a meeting to thereby provide a real space meeting service.

From a viewpoint of posting in a real space, a user first registers photographs and writing at his location in the real space. At this time, other users near the user who registered the photographs and writing can annex replies at the sight of the posted photographs and writing. Then, the user who posted the photographs and writing can confirm response of other users through the number of replies or inquiries of other users. In addition, from a viewpoint of meeting inducement, a meeting is proposed to users having the same interest through the above-mentioned posting activity. At this time, other users near the user who registered the photographs and writing confirm a fact of the proposal of meeting and notice the attendance or nonattendance at the proposed meeting. Then, an off-line meeting between users who confirm the attendance or nonattendance at the meeting and notice the attendance at the meeting through above-mentioned procedures is established. On the other hand, from a viewpoint of relationship formation, a relationship through an interaction between users can be naturally formed through the above-described posting writing/confirmation, meeting proposal and meeting activity.

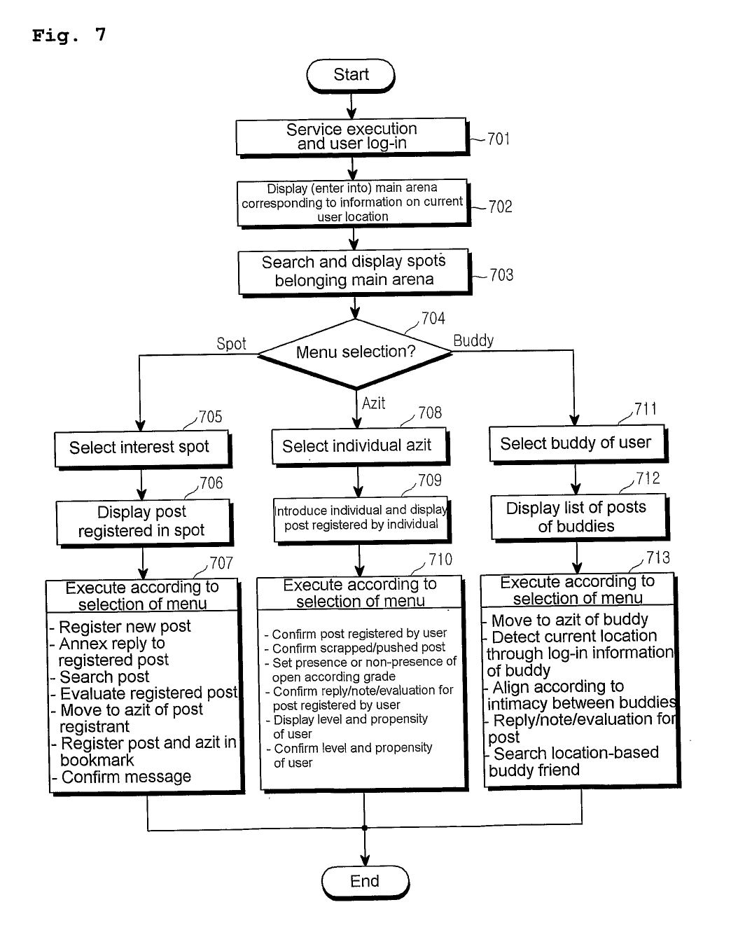

So far, the services provided according to the present invention have been described. Hereinafter, a detailed service provision procedure according to an embodiment of the present invention will be described with reference to FIG. 7.

FIG. 7 is a flow chart illustrating a procedure of providing a moblog-based regional community service through a mobile terminal according to an embodiment of the present invention. Referring to FIG. 7, a user first executes a moblog-based regional community service and a user log-in through his mobile terminal (Step 701). At this time, a main arena corresponding to information on a current location of the user is displayed according to the location-based system (Step 702) That is, the user enters the main arena. The main arena may be displayed in various forms of administrative units such as city, country, district, town, township, village or the like. For example, the main arena may has names of administrative districts such as Kangnam subway station, Apkoogung, Myungdong, Jongro and the like. The main arena is based on an actual location at which the user is currently located, and may be automatically set by detecting the user's location when the user moves to be within an area of a particular main arena.

When the user logs in and enters the main arena, the location-based community server 350 searches spots belonging to the main arena and displays the searched spots on the mobile terminal of the user (Step 703). At this time, the user can receive a certain service by selecting one of spot, azit and buddy menus according to an embodiment of the present invention (Step 704).

First, when the user selects one of spots corresponding to the main arena from the spot menu (Step 705), a list of posts registered in the selected spot is displayed (Step 706) Then, by selecting one post from the displayed list of posts, writing or photographs for the selected post can be read or viewed. In addition, in the spot menu, a variety of works according to a provided additional selection menu can be performed (Step 707).

For example, a work of registering a new post or registering a reply in a registered post can be performed. In addition, a post search or an evaluation on a registered post can be performed. In addition, a user can move to an azit of a post registrant in a read post. Accordingly, other writing registered by the user who registers the post can be read. In addition, posts or azits of interest can be registered as a bookmark. As an additional function, a message box of a user can be confirmed.

On the other hand, when a user selects an individual azit menu (Step 708), the user can display only an introduction to him and posts registered by him (Step 709). That is, when the user registered the posts through various spots, the posts registered in the various spots can be collectively confirmed from the individual azit menu. In addition, in the individual azit menu, a variety of works can be performed according to a provided additional selection menu (Step 710). For example, the posts registered by the user or the posts scrapped or pushed by the user can be confirmed. In addition, the service can be implemented such that information on the user's personal affairs or writing or photographs registered by the user can be opened to only qualified users by setting whether or not the information, writing or photographs are be opened according to a grade. In addition, replies, notes or evaluation for a post registered by the user can be confirmed, or level or propensity of the user can be indicated or confirmed.

On the other hand, when the user selects the buddy menu (Step 711), a list of buddies linked to the user is displayed. When one of the buddies is selected, a list of posts registered by the selected buddy is displayed (Step 712).

In addition, in the buddy selection menu, a variety of works can be performed according to a provided additional selection menu (Step 713). For example, the user can move to an azit of the selected buddy or know a current location of the buddy through log-in information of the buddy. In addition, a degree of intimacy is granted among buddies and an alignment according to the degree of intimacy is possible. In addition, replies, notes or evaluation can be registered in posts registered by the buddies.

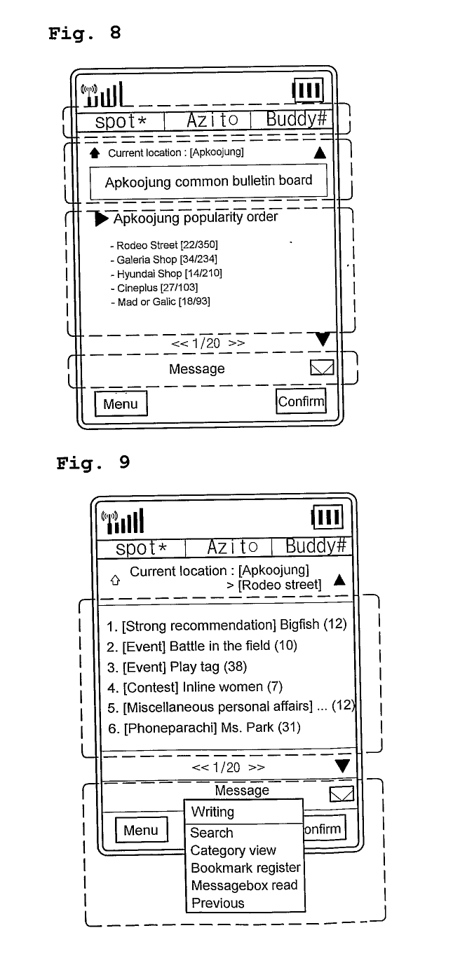

Hereinafter, service methods through the above-described spot, azit and buddy menus provided according to an embodiment of the present invention will be described with reference to FIGS. 8 to 13.

FIGS. 8 and 9 are diagrams illustrating a service method through the spot menu of a mobile terminal according to an embodiment of the present invention. Referring to FIG. 8, the spot menu is activated to provide a space where a relevant user and other users share their writing in a desired location (spot) or expand and deepen an interrelationship through a meeting among users having the same interest.

The spot means a point (for example, a Rodeo street) existing in a real location, as described above, and is a common theme space that users make together. Accordingly, the spot allows formation of a bulletin board in the unit of theme as a public location. A main arena, that is, a current location, is indicated as ‘Apkoojung’ in the spot menu. The current location is provided by detecting a position of a mobile terminal carried by the user using the location-based system (LBS). That is, the main arena means urban main centers and sub centers according to the location-based system. A common bulletin board is a place where events and announcement is viewed in the spot.

On the other hand, when the user enters the main arena as described above, a list of spots included in the main arena is displayed according to a prescribed order (for example, a popularity order). Here, by highlighting a certain spot in the list of spots, it can be seen that there is a link to a spot of. In addition, a message box function is added in the bottom of the spot menu to read notes provided to the user or confirm posts and meeting announcement registered by his friends.

When one spot (for example, a Rodeo street) in the list of spots is selected, a list of posts registered in the selected spot is displayed as shown in FIG. 9. Referring to FIG. 9, a list of posts registered in the selected spot, that is, the Rodeo street, is displayed. The list of posts is a bulletin posted by users in the selected spot. The users can post a variety of subjects including miscellaneous personal affairs, remembrance leaving, announcement of events and meetings hold by a region and a store and the like in this bulletin. After selecting one post in the list of posts, the selected post can be read and evaluated, or replies can be registered in the selected post. Thus, interchange of information between a post registrant and other users is possible and other users can be induced to an azit of a post maker through the post. On the other hand, by highlighting a certain post in the list of posts, it can be seen that the highlighted post is a post registered by the user's buddy.

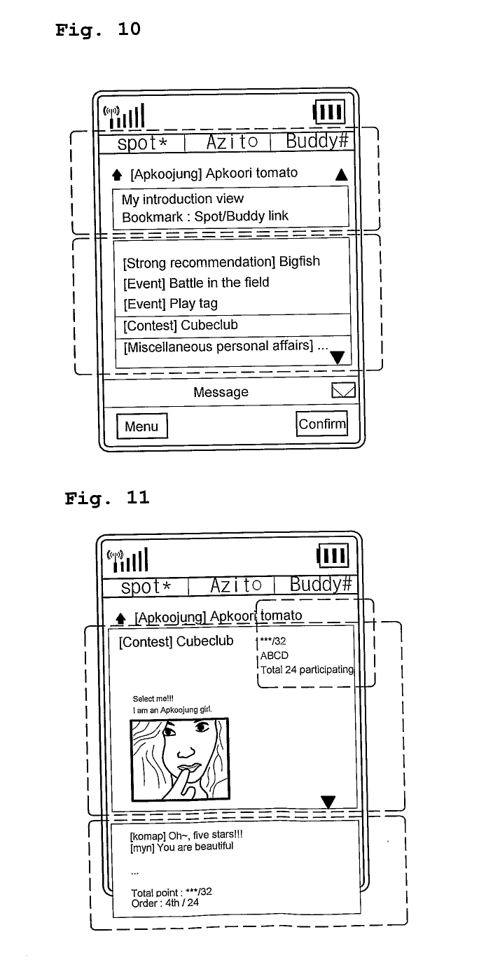

FIGS. 10 and 11 are diagrams illustrating a service method through an azit menu of a mobile terminal according to an embodiment of the present invention. Referring to FIG. 10, all information on an individual used to form a connection with other persons through the individual azit menu is stored, and a level, propensity and the like of the individual can be indicated. Thus, identity of the individual can be expressed, and an active posting activity in the spots can be induced by providing a link to other persons who do not make buddies.

The user space, that is, the azit, which is a user's residing space in the main arena, is a location at which the user can meet his friends in regions centered at the user and is his own space where the user can express and decorate him. A list of posts registered by the user and posts scrapped or pushed by the user are displayed on the azit menu. In addition, presence or non-presence of open for the posts can be set in such a manner that whether or not the posts are opened depends on a grade of relationship. On the other hand, when one post in the displayed list of posts is selected, contents of the selected post is displayed as shown in FIG. 11.

Referring to FIG. 11, the post may include writing and photographs used to advertise the user himself. That is, propensity of the user and tendency to the user's interest are expressed by individual posts successively registered in the user's azit. On the other hand, the posts registered in the spot shown in FIG. 8 are also registered in the azit menu simultaneously, as described above. Replies or evaluations registered by other users after other users read the posts are displayed on the bottom of the post menu. That is, other users read the posts of the relevant azit can annex replies, notes or evaluations to the posts. In addition, instant grouping and meeting can be induced. In addition, there may be provided a field of association and expression between users by sharing information, interest and meeting between the users through the post in the azit.

On the other hand, the post registered in the azit may be analyzed to indicate the level and propensity of the user. That is, the level and propensity of the user can be analyzed by analyzing and indexing an extent of experience, a relationship index, evaluation items and the like of the user using a system.

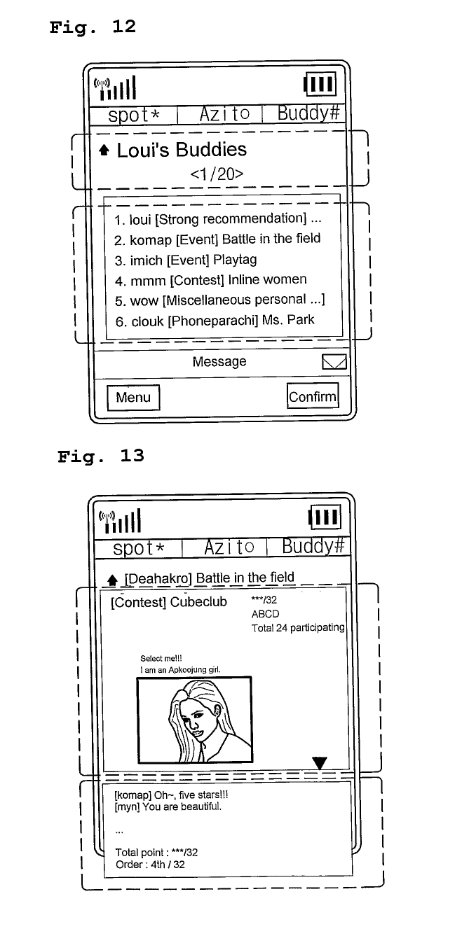

FIG. 12 is a diagram illustrating a service method through a buddy menu of a mobile terminal according to an embodiment of the present invention. Referring to FIG. 12, buddies associated with the user are stored and managed through the buddy menu, and an interrelationship between the user and the buddies can be deeply developed by recognizing conditions of activity (for example, presence information, individual posts registered by the buddies, azits of the buddies and the like) of the buddies (human connections) at the user's location.

The buddy menu is a space shared with the user’ s friends and also a post space of acquaintances formed according to the user’ s human connection. Accordingly, new posts of the buddies are listed and shown, and a link allowing a direct movement to azits of the buddies can be provided. In addition, immediacy through a real time alarm can be provided. On the other hand, a list of posts provided in the buddy menu includes posts registered by the user's buddies. The user can know current activities and conditions of buddies who registered the posts through the registered posts. In addition, the posts are aligned according to a degree of intimacy among the buddies.

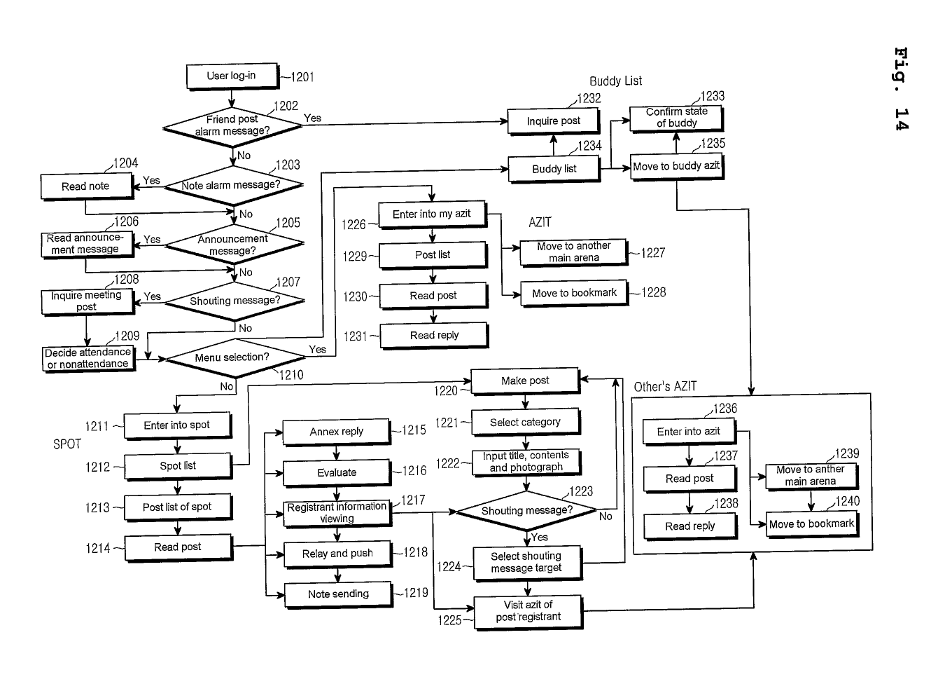

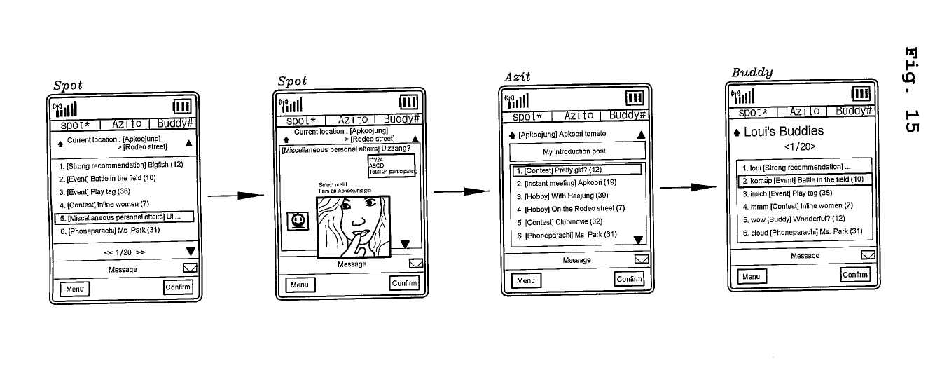

At this time, when one post in the list of posts is selected, the buddy menu is changed to an azit menu, as shown in FIG. 13, where contents of a relevant post are displayed in the form of a text or an image. Referring to FIG. 13, the displayed contents of the post may be configured as writing and photographs to advertise a relevant buddy. That is, propensity of the buddy and tendency to the buddy's interest are expressed by individual posts registered by the buddy. Replies or evaluations registered by other users after other users read the posts are displayed on the bottom of the post menu. That is, other users who read the posts of the buddy can annex replies, notes or evaluations to the posts. In addition, instant grouping and meeting can be induced. In addition, there may be provided a field of association and expression between users by sharing information, interest and meeting between the users through the posts in the buddy.

FIG. 14 is a diagram illustrating an entire service flow through a menu provided through a mobile terminal according to an embodiment of the present invention. Referring to FIG. 14, when a user logs-in (Step 1201) and a friend post alarm message appears (Step 1202), a control flow moves a relevant buddy list in order to inquire posts (Step 1232). In addition, when a note alarm message appears (Step 1203), the note is read (Step 1204), and when an announcement message appears (Step 1205), the announcement is read (Step 1206). If a shouting message appears (Step 1207), a post informing a meeting is inquired (Step 1208) and then the attendance or nonattendance is decided (Step 1209).

On the other hand, when the user selects a menu (Step 1210) and enters into a spot menu (Step 1211), a list of spots is displayed (Step 1212). When the user selects a particular spot in the list of spots, a list of posts of the selected spot is displayed (Step 1213). When a particular post in the list of posts is selected, the selected post is displayed (Step 1214). Functions of reply annexation (Step 1215), evaluation (Step 1216), post registrant information viewing (Step 1217), relay and push (Step 1218), note sending (Step 1219) and the like can be performed in the selected post.

Here, when the user selects the post registrant information viewing (Step 1217), he visits an azit of the post registrant (Step 1225) and enters into the azit of the post registrant (Step 1236) in order to confirm the post (Step 1237) and register a reply (Step 1238).

On the other hand, when the user selects a menu (Step 1210) and enters into an azit menu (Step 1226), a list of spots registered in an azit of the user is displayed (Step 1229). When the user selects and reads a particular post in the list of posts (Step 1230) and confirms registered replies (Step 1231). On the other hand, the user can move from the azit to another main arena (Step 1227) or move from the azit to another azit or spot through a bookmark menu (Step 1228).

When the user selects a menu (Step 1210) and enters into a buddy menu, a list of buddies of the user is provided (Step 1234) and state information of each buddy is displayed (Step 1233). In the buddy menu, the user can inquire posts registered by the buddies (Step 1232) or move to an azit of a relevant buddy (Step 1235).

When the user selects movement to the azit of the buddy (Step 1235), he enters into the azit of the buddy (Step 1236) in order to confirm the posts registered by the buddy (Step 1237) and register a reply (Step 1238). In addition, the user can move from the azit of the buddy to another main arena (Step 1239) or move from the azit of the buddy to another azit or spot through a bookmark menu (Step 1240).

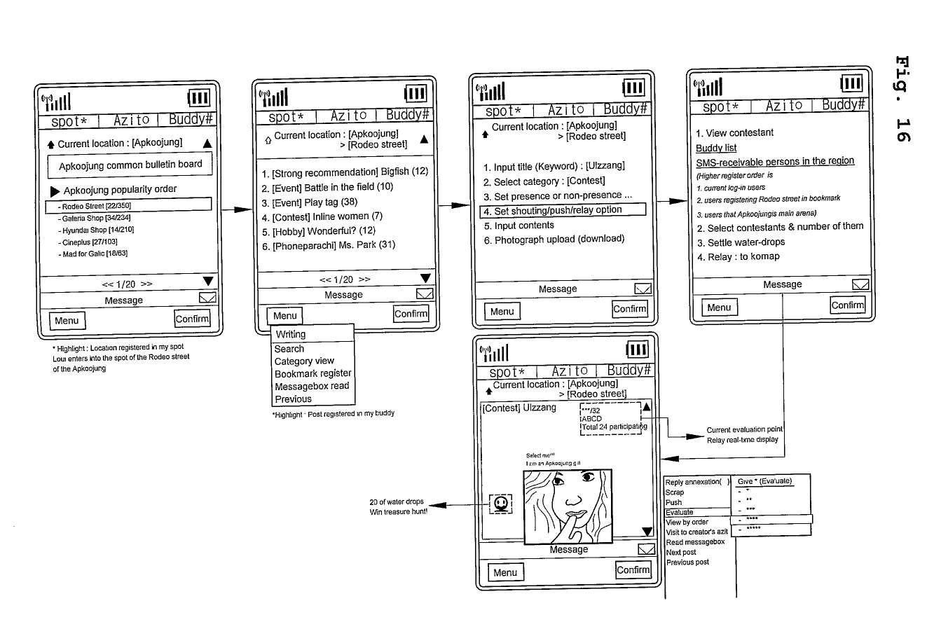

FIG. 15 is a diagram illustrating a service link procedure through spot, azit and buddy menus according to an embodiment of the present invention. Referring to FIG. 15, as shown in FIGS. 8 to 10, a basic blogging is conducted in the spot, the azit of the user is filled through the blogging, and a relationship structure where buddies are formed through the azit is formed. Accordingly, spot, azit and buddy service modules are interconnected organically, not separately, forming an entire communication flow of the services.

For example, a user A locating at Apkoojung enters into a spot [Rodeo street] of spots taking the Apkoojung as a main arena. When the user A selects the spot, a list of posts registered in the spot is displayed. The user selects one post in the list of posts in a first spot menu. For example, No. 5. ‘[miscellaneous personal affairs] ulzzang?’ (‘ulzzang’ means a good face) registered by a user B is selected. According to the selection, contents of the selected post is displayed in a second spot menu. That is, the user A reads the post registered in the spot by the user B, taking an interest in the user B. Then, when the user A selects ‘[Azit viewing]’ of the user B who registered the post in contents of the post, a third azit menu is provided.

A selected azit of the user B is displayed in the third azit menu. That is, the user A visits the azit of the user B through the post registered in the [Rodeo street] spot by the user B and gets acquainted with the user B by reading a post registered in Apkoogung by the user B. Then, the user A requests the user B to provide a buddy.

When the user B accepts the request for the buddy from the user A, the users A and B form a new interrelationship, i.e., a buddy relationship. Accordingly, new writing registered in Apkoojung by the buddy can be read, and varying situation of the buddy can be confirmed in real time.

FIG. 16 is a diagram illustrating an execution procedure in a spot menu of a mobile terminal in a moblog-based regional community service according to an embodiment of the present invention. Referring to FIG. 16, when a user locates at Apkoojung as mentioned above, spots for a relevant main arena are displayed according to a popularity order. When the user enters into the Rodeo street spot in the list of spots, the list of posts registered for the Rodeo street is provided. Writing, search, bookmark, message box reading and the like can be performed through a separate menu in the list of posts.

Here, when the writing is selected, according to a writing menu, a title (keyword) is inputted, a category is selected, and presence or non-presence of open is set. In addition, a shouting/push/relay option is set, contents are inputted, and photographs are put on. Here, when the shouting menu is selected, a list of buddies or a list of SMS-receivable persons in the region is confirmed, and relevant contents can be shouted/pushed/relayed.

When a ‘[contest] ulzzang’ menu is selected from the list of posts of the spot, writing and photographs registered by contestants are displayed, and menus such as reply annexation (notes/SMS), scrapping, pushing, evaluation, viewing by order, visit to creator's azit, message box read, next post, previous post and the like can be performed.

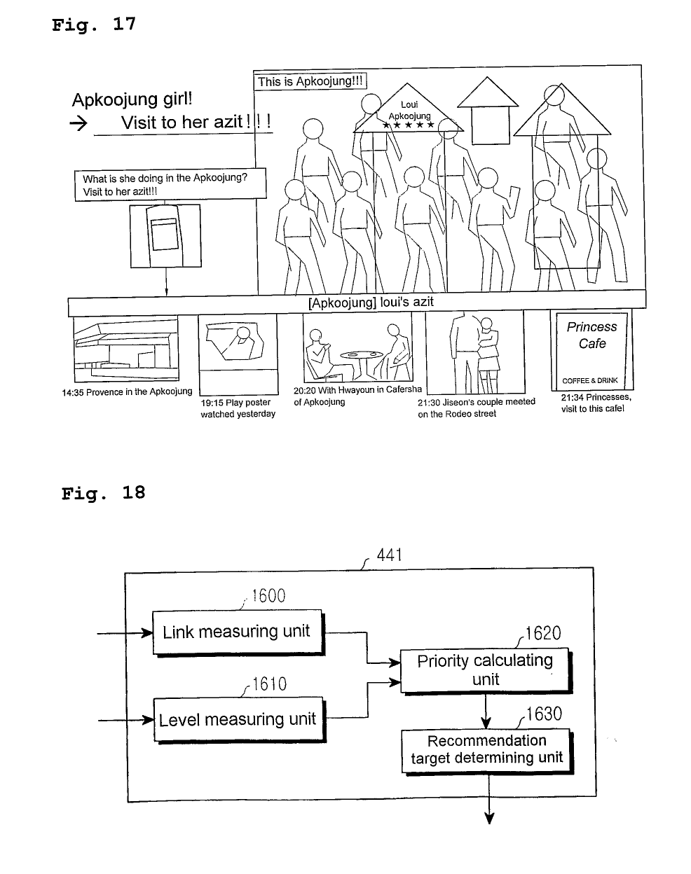

FIG. 17 is a diagram illustrating a service use condition using an azit function in a moblog-based regional community service according to an embodiment of the present invention. Referring to FIG. 17, at the sight of the ‘[contest]ulzzang’ post shown in FIG. 16, the user is interested in the contestants and may move to azits of the contestants. The user may confirm posts registered in the azits of the contestants, and accordingly, interest fields and experiences of the contestants may be shared by other users through the posts registered by the contestants. In addition, the users may directly visit or experience locations visited by the contestants.

On the other hand, as described above, the present invention executes a recommendation algorithm to allow a meeting on-line to naturally continue off-line and expand additional human connections with persons having the same interest.

Hereinafter, methods of executing a recommendation algorithm according to an embodiment of the present invention will be described with reference to FIGS. 18 to 22. The recommendation algorithm is divided into recommendation of spots, recommendation of azits and recommendation of targets of message delivery, as described above.

FIG. 18 is a block diagram illustrating a detailed structure of a recommendation engine for executing a recommendation algorithm according to an embodiment of the present invention. Referring to FIG. 18, a recommendation system 441 according to an embodiment of the present invention may include a link measuring unit 1600, a level measuring unit 1610, a priority calculating unit 1620, and a recommendation target determining unit 1630. In addition, the recommendation system 441 may be incorporated in a recommendation algorithm module 440 of the location-based community server 350 as shown in FIG. 4.

The link measuring unit 1600 measures an azit to azit or azit to spot link (relationship). Such a measurement is achieved through the number of inquiries, evaluations, replies, bookmarks the number of times of note delivery and the like. The level measuring unit 1610 measures levels of azits and spots based on the number of links to other azits and spots or a degree of activity of user's azits, details of which will be described later. The priority calculating unit 1620 calculate a recommendation priority of a relevant spot or azit based on a value of link measured by the link measuring unit 1600 and a value of level measured by the level measuring unit 1610. The recommendation target determining unit 1630 determines a recommendation target of the spot or azit based on the priority calculated by the priority calculating unit 1620. Details of the calculation and the determination will be described later.

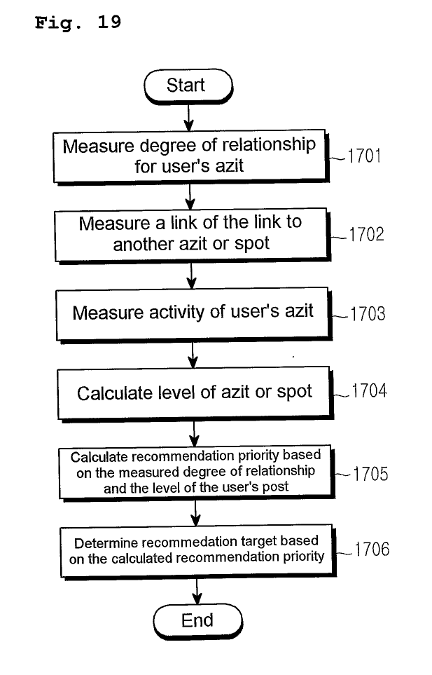

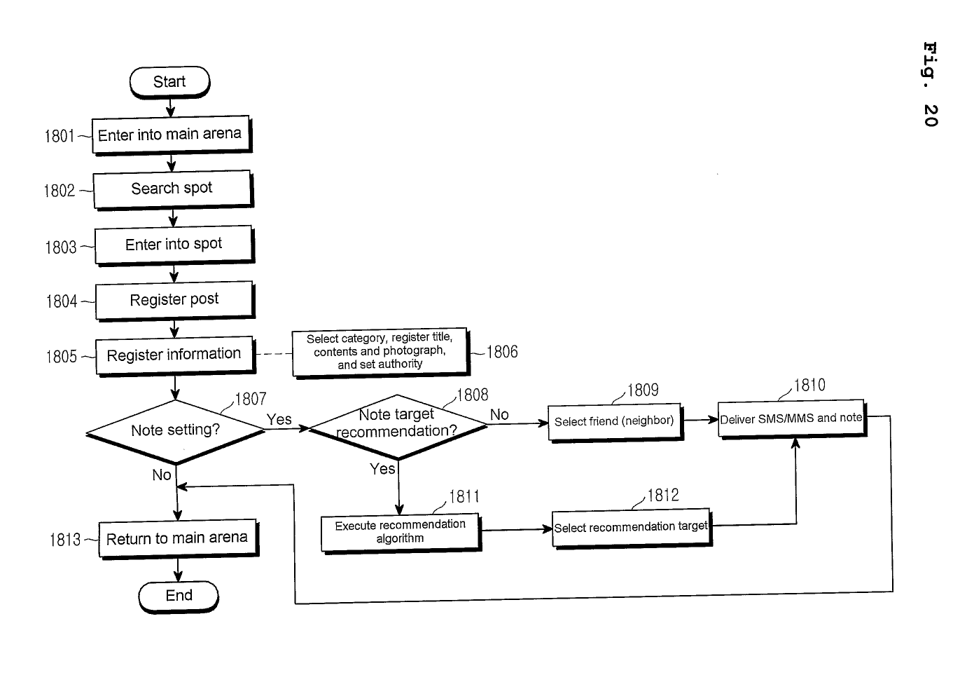

FIG. 19 is a flow chart illustrating a procedure of recommending an azit according to an embodiment of the present invention. Referring to FIG. 19, the recommendation system 441 measures a degree of relationship of a user with a relevant azit (Step 1701) Then, the recommendation system 441 measures a link of the link to another azit or spot (Step 1702) In addition, the recommendation system 441 measures activity of the user's azit (Step 1703).

Then, a level of the azit and spot is calculated based on resultant values of the above measurements (Step 1704). Thereafter, a recommendation priority is calculated based on the measured degree of relationship and level of the user's post (Step 1705). Finally, a recommendation target is determined based on the calculated recommendation priority (Step 1706).

Hereinafter, the recommendation algorithm shown in FIGS. 16 and 17 will be described in more detail.

As described above, the recommendation algorithm according to the embodiment of the present invention can be applied to three cases, that is, recommendation of spots, recommendation of azits and recommendation of targets of message delivery. The recommendation algorithm is performed according to the following procedures. The following detailed embodiment is to be provided to assist a thorough understanding of the present invention and it should be appreciated that the embodiment may be changed in various ways using concepts or principles of algorithm to be described.

First, an azit to azit or azit to spot link (relationship) is measured. The link is measured based on experience of inquiry of user to post, evaluation and the number of replies to the post, setting of bookmark by the user, and the number of notes delivered to other azits by the user.

For example, in connection with the experience of inquiry of user (azit) to post, a score of experience of inquiry may be set to be 0.1 to 0.3. That is, 0.1 is set for one to five times of inquiry, 0.2 is set for six to ten times of inquiry, and 0.3 is set for more than ten times of inquiry. In addition, in connection with the evaluation and the number of replies of the user (azit) to the post, an evaluation function is provided to the post, values of 0.05 to 0.25 are set for post evaluation scores of 1 to 5, respectively, and 0.1 per time is set for replies of the post. In addition, in connection with setting of bookmark by the user, 0.1 is set for setting of post bookmark and 0.3 is set for setting of bookmark (neighbor) of a spot or azit including the post, and, in connection with the number of notes delivered to other azits by the user (azit), 0.1 per SMS or MMS may be set for each note.

With the above settings, the measurement of the link can be calculated by the sum of values set as described above. For example, assuming that the user (azit) inquired three posts in other azits or spots (corresponding to 0.1 point), granted an evaluation score of 4 to one post (corresponding to 0.2 point), bookmarked two posts (corresponding to 0.2 point=0.1*2), and bookmarked other azits or spots (corresponding to 0.3 point), a link (relationship) of the user (azit) to other azits or spots marks 0.8 point=0.1+0.2+0.2+0.3.

Second, a method of measuring levels (ranks) of azits and spots will be described. The level may be measured by the sum of links (relationships) (denoted as \textcircled{1}× hereinafter) to other azits or spots and the sum of activities (denoted as \textcircled{2}) performed by the user (azit). For example, scores may be set as follows:

| | |
|---|---|
| number of posts | (0.2 * number of posts) |
| post bookmark | (0.05 * number of bookmarks) |
| azit and spot bookmark | (0.05 * number of bookmarks) |
| number of delivery of notes, SMSs, and | (0.1 * number of delivery) |
| MSMs | |
| number of replies | (0.05 * number of replies) |
| number of evaluations | (0.05 * number of evaluations) |
| number of buddy permissions or | (0.3 * number of times) |
| requests | |

with such setting, when the sum of links is added to the sum of activities of the user azit (that is, \textcircled{1}+\textcircled{2}), the level (rank) of the azit or spot) is measured.

For example, assuming that there are two links to an azit and degrees of connection for the two links are 0.8 and 1.4, respectively, a value of \textcircled{1} becomes 2.2. In addition, assuming that the number of posts of the user is two (0.4 point), the number of bookmarks of the post by the user is two (0.1 point), and the number of replies to other posts by the user is four (0.2 point), a value of \textcircled{2} becomes 0.7. Consequently, a value of the level of the azit becomes 2.9 (\textcircled{1}+\textcircled{2}).

Then, the recommendation priority calculation performed third according to the recommendation algorithm is made based on two factors for the link (degree of connection) and the level. For example, the recommendation priority may be calculated according to the following Equation 1.
(Recommendation priority)=(Degree of connection of link)×(Level) Equation 1

Accordingly, a personalized priority can be derived according to the calculated recommendation priority. Examples of derivation of the personalized priority are shown in the following Table 1.

TABLE 1

| Division | Content |
|---|---|
| Calculation | 1. Interest spot |
| method of spot | (link to my azit (degree of connection)) × (level |
| recommendation | of spot) |
| priority | 2. Interest spot of friend |
| | (link to my azit (degree of connection)) × (level |
| | of friend azit) × (link |
| | (degree of connection) to friend azit) × (level |
| | of spot) |
| | 3. Regional popular spot |
| | (0.1 (basic value)) × (level |
| | of spot itself) |
| Calculation | 1. Friend (neighbor) azit |
| method of azit or | (ink to my azit (degree of connection) × (level |
| friend (neighbor) | of friend (neighbor) azit) |
| recommendation | 2. Friend (neighbor) azit of friend (neighbor) |
| priority | (link to my azit (degree of connection)) × (level |
| | of friend (neighbor) azit) × (link |
| | to friend (neighbor) azit) × (level |
| | of friend (neighbor) azit) |
| | 3. Azit related to interest spot |
| | (link to my azit (degree of connection)) × (level |
| | of spot) × (link |
| | (degree of connection) to spot) × (level |
| | of azit) |
| | 4. Regional popular azit |
| | (0.1 (basic value)) × (level of azit) |

Finally, the calculated numerical values are ranked, and azits, spots, friends (neighbors) and the like may be recommended based on the ranked numerical values.

Accordingly, it is possible to provide customized information suitable to wired/wireless environments based on the recommendation priority on which the level of the azit and spot itself as well as the link (degree of connection) concerned by users is reflected. In addition, in measuring the recommendation priority using the degree of connection of link and the level, the human connection can be expanded to more than three phases.

On the other hand, weights may be granted to the degree of connection of link and the level, respectively, depending on a service model. For example, the recommendation priority may be calculated according to the following Equation 2.
(Recommendation priority)=(Weight (A))×(Degree of connection of link)×(Weight (B))×(Level) Equation 2

Thus, azits and spots can be aligned according to the recommendation priority calculated using the Equation 2. Accordingly, an azit and spot may be recommended to a relevant user when a calculated value of the azit and spot exceeds a prescribed value.

So far, the method of determining a recommendation target by calculating the recommendation priority has been described. Hereinafter, conditions under which the recommendation algorithm is applied will be described with reference to FIGS. 18 to 20.

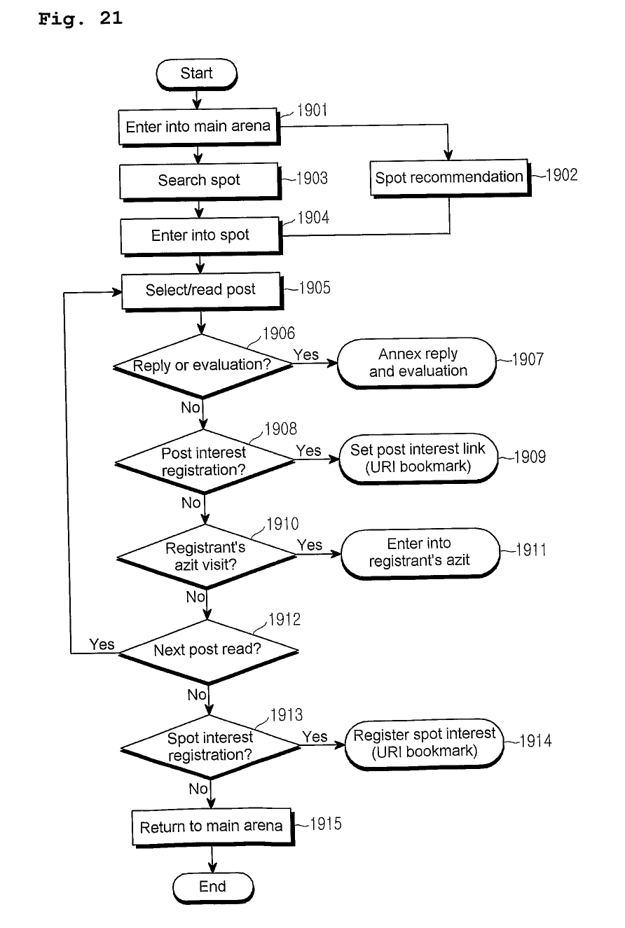

FIG. 20 is a flow chart illustrating a procedure in which a condition of recommending a message target occurs according to an embodiment of the present invention. That is, FIG. 20 is a service flow diagram illustrating registration of a post by a user and delivery of announcement of the registered post to a recommended neighbor.

Referring to FIG. 20, the user enters into a relevant main arena on the basis of LBS, as described above, searches spots in the main arena, and then enters into a searched spot. Then, the user selects a post registration menu in order to register a post, which is the unit of registration of information, in the spot, and inputs a category, a title, contents, photographs, settings of authority and the like in the post registration menu.

In this case, the user can deliver notes in order to recommend the registered post. At this time, a target of the delivery of notes may be selected among the user's existing friends or may be a recommendation target selected according to the recommendation algorithm according to the embodiment of the present invention.

Once the recommendation target is decided, a note or the registered post with SMS or MMS is delivered to the decided recommendation target.

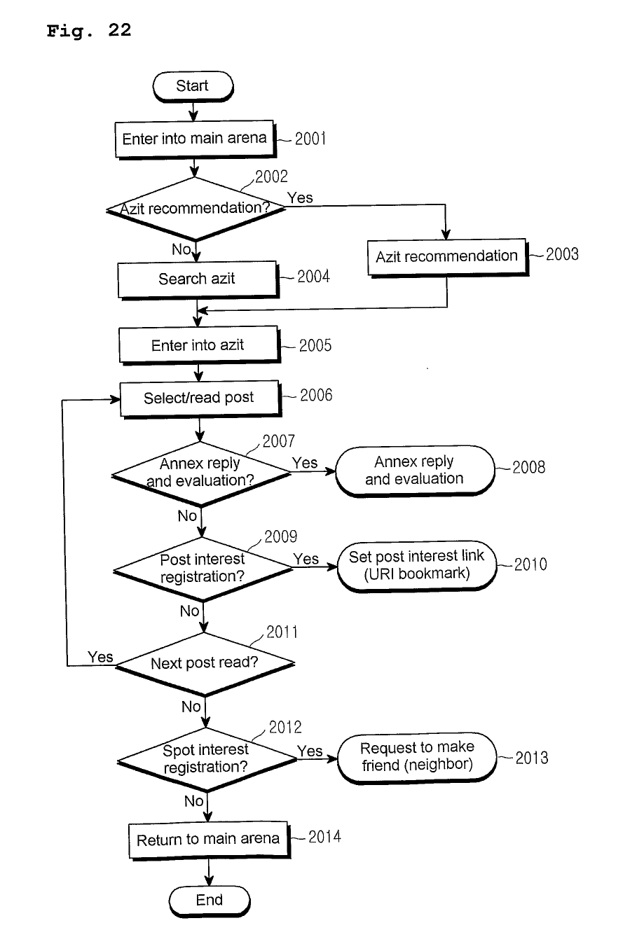

FIG. 21 is a flow chart illustrating a procedure in which a condition of recommending a spot occurs according to an embodiment of the present invention. Referring to FIG. 21, a user may enter into a spot searched by the user himself or a spot recommended according to the recommendation algorithm. In this case, a method of recommending the spot based on the recommendation algorithm is as described above.

Once the spot is selected through the search or the recommendation algorithm, a list of posts registered in the spot is displayed. The user may read a particular post in the spot and annex a reply or an evaluation for the particular post. In addition, the user may register the post in a bookmark or visit an azit of a person who registered the post. In addition, the user may register the searched or recommended spot in the bookmark.

FIG. 22 is a flow chart illustrating a procedure in which a condition of recommending an azit occurs according to an embodiment of the present invention. That is, FIG. 22 is a flow diagram illustrating a procedure in which a user reads a post registered in an azit searched by the user himself or an azit recommended according to the recommendation algorithm and annexes a reply to the post or requests a friend.

Referring to FIG. 22, the user may select an azit searched by the user himself or an azit recommended according to the recommendation algorithm. Once the azit is selected through the search or the recommendation, the user may read the post registered in the selected azit. Then, the user may an next a reply or evaluation to the read post and register the read post in a bookmark. In addition, the user may request the azit to form a friend relationship with the user.

As can be seen from the procedures shown in FIGS. 20 to 22, there may occur conditions of selection of the note delivery target, spot and azit in the present invention. In such a case, the user may select the note delivery target, spot and azit through the search or the recommendation algorithm according to the embodiment of the present invention.

As apparent from the above description, according to the present invention, a concept of ‘location’ is introduced in a moblog and communities between users can be formed by the medium of the location. On the basis of such communities, a real off-line meeting as well as an on-line meeting is induced to thereby expand a human network.

In addition, the present invention has advantages of utilization of a variety of services including location-based remembrance leaving, location bulletin board, location 9store) advertisement, evaluation on locations, regional event announcement, participation in regional contests, location-based meeting announcement and the like.

In addition, the present invention has advantages in that it is possible to provide customized information suitable to wired/wireless environments based on the recommendation priority on which the level of the azit and spot itself as well as the link (degree of connection) concerned by users is reflected. In addition, in measuring the recommendation priority using the degree of connection of link and the level, the human connection can be expanded to more than three phases.

Furthermore, the present invention has advantages in that the human connection recommendation method according to the embodiment of the present invention may contribute to form a new friend or neighboring relationship between users, and on-line or off-line meetings can be announced to relevant users in real time through SMS, MMS or the like.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

What is claimed is:

1. In a location-based community service provision system for setting a plurality of main arenas by dividing a geographical area in a regional unit, setting and storing one or more virtual spatial locations, the one or more virtual spatial locations being a projection of real spatial public locations, as spots in one of the main arenas, receiving information on posts registered in spots transmitted through a mobile terminal by providing one or more pieces of information on the spots belonging to the main arena from information on a location of the mobile terminal to the mobile terminal, and storing the received information on posts with a link with the spots, an apparatus for recommending a spot or an azit in a moblog-based regional community system using a mobile terminal, comprising:
a recommendation system for executing a predetermined recommendation algorithm to recommend azits, spots, friends or neighbors for each user;
a level system for setting and managing a level for each azit and spot according to a preset rule; and
a link evaluator for performing an evaluation on each link and managing a result of the evaluation.

2. The apparatus according to claim 1, wherein the recommendation system includes:
a link measuring unit for measuring a relationship including user information between the user's azit and other user's azits or between the user's azit and the spots;
a level measuring unit for measuring levels of the azits and/or spots;
a priority calculating unit for calculating a recommendation priority of the spots and/or azits based on a value of link measured in the link measuring unit and a value of level measured in the level measuring unit; and
a recommendation target determining unit for determining a recommendation target of the spots and/or azits based on the priority calculated in the priority calculating unit.

3. The apparatus according to claim 2, wherein the recommendation system measures the relationship including user information between the user's azit and other user's azits or between the user's azit and the spots in the link measuring unit, based on at least one of the number of inquiries, the number of evaluations, and the number of times of bookmark and note delivery.

4. The apparatus according to claim 2, wherein the level measuring unit measures the levels of the azits and spots based on the number of links to other azits and spots.

5. The apparatus according to claim 2, wherein the level measuring unit measures of the levels of the azits and spots based on activities performed by user's azits.

6. In a location-based community service provision system for setting a plurality of main arenas by dividing a geographical area in a regional unit, setting and storing one or more virtual spatial locations, the one or more virtual spatial locations being a projection of real spatial public locations, as spots in one of the main arenas, receiving information on posts registered in spots transmitted through a mobile terminal by providing one or more pieces of information on the spots belonging to the main arena from information on a location of the mobile terminal to the mobile terminal, and storing the received information on posts with a link with the spots, a method for recommending a spot or an azit in a moblog-based regional community system using a mobile terminal, the method comprising the steps of:
measuring a relationship between user's posts;
measuring a link of a user’s azit to other user’s azits and/or spots;
measuring activities performed by the user's azit;
calculating levels of the azits and spots based on values derived from the measurements;
calculating a recommendation priority based on a degree of relationship and a level of the user's post; and
determining a recommendation target based on the calculated recommendation priority.

7. The method according to claim 6, wherein the step of measuring the relationship between user's posts is performed based on at least one of the number of inquiries, the number of evaluations, and the number of times of bookmark and note delivery.

8. The method according to claim 6, wherein, in the step of calculating the levels, the levels are calculated by measuring the number of links to other azits and spots.

9. The method according to claim 6, wherein, in the step of calculating the levels, the levels are calculated by measuring activities performed by user's azits.
